(19) United States
(12) Patent Application Publication
(10) Pub. No.: US 2018/0240591 A1
(43) Pub. Date: Aug. 23, 2018

(54) ELECTRONIC COMPONENT

(71) Applicant: TDK CORPORATION, Tokyo (JP)

(72) Inventors: Yuya ISHIMA, Tokyo (JP); Yasushi MATSUYAMA, Tokyo (JP); Yuto SHIGA, Tokyo (JP); Shunji AOKI, Tokyo (JP); Shinichi KONDO, Tokyo (JP)

(73) Assignee: TDK CORPORATION, Tokyo (JP)

(21) Appl. No.: 15/892,784

(22) Filed: Feb. 9, 2018

(30) Foreign Application Priority Data
Feb. 22, 2017 (JP) 2017-031175

(51) Int. Cl. H01F 41/04; H01F 27/28; H01F 27/32

(52) U.S. Cl. CPC H01F 41/04; H01F 27/323; H01F 27/28

(57) ABSTRACT

An electronic component includes an element provided with a first recess, and a mounting conductor including a first conductor portion disposed in the first recess. The first conductor portion has a first face opposed to a bottom face of the first recess, a second face opposed to the first face, and a third face connecting the first face and the second face. The third face has a region overlapping with the second face as viewed from an opposing direction of the bottom face of the first recess and the first face.

### TECHNICAL FIELD

One aspect of the present invention relates to an electronic component.

### BACKGROUND

Known electronic components include a chip and a mounting conductor provided on a surface of the chip. In the electronic components, the mounting conductor is formed on an outer surface of the chip, and thus the size of the chip needs to be smaller by one size than a predetermined size of the electronic component. Therefore, the volume of the chip may not be sufficiently secured in some cases. In view of the foregoing, Japanese Patent No. 4816971 discloses an electronic component including an element and a mounting conductor disposed in a recess provided in the element. In the electronic component, the mounting conductor is disposed in the recess, and thus the volume of the element can be secured.

### SUMMARY

In the above-described electronic component, cracks sometimes occur in the element.

One aspect of the present invention provides an electronic component in which the occurrence of cracks in the body is suppressed.

According to research and study by the inventors of the present invention, it has turned out that cracks are more likely to occur in the element due to the fact that the shrinkage amount of the configuration material of the mounting conductor is larger than the shrinkage amount of the configuration material of the element, shrinkage being caused due to thermal treatment in manufacturing the electronic component. Therefore, if the volume of the mounting conductor is reduced, the shrinkage amount of the configuration material of the mounting conductor can be reduced. However, to keep the mounting strength, it is necessary to maintain the area of the outer surface of the mounting conductor.

Therefore, an electronic component according to one aspect of the present invention includes an element provided with a first recess, and a mounting conductor including a first conductor portion disposed in the first recess. The first conductor portion has a first face opposed to a bottom face of the first recess, a second face opposed to the first face, and a third face connecting the first face and the second face. The third face has a region overlapping with the second face as viewed from an opposing direction of the bottom face of the first recess and the first face.

In this electronic component, the third face has the region overlapping with the second face as viewed from the opposing direction of the bottom face and the first face. Therefore, the volume of the first conductor portion can be reduced while the area of the second face is maintained, as compared with a case where the third face is provided in such a way as not to overlap with the second face. Therefore, since the shrinkage amount of a configuration material of the first conductor portion can be reduced, occurrence of cracks in the element is suppressed.

In the electronic component according to one aspect of the present invention, the region may be curved. For example, in a case where the region is configured from a plurality of planes and has a chamfered shape, there is a possibility of concentration of stress on corner portions of the region. In contrast, in the electronic component according to one aspect of the present invention, the region is curved and thus the stress can be relieved. Therefore, occurrence of cracks in the element is further suppressed.

In the electronic component according to one aspect of the present invention, the first face may have a first outer edge that defines the region, and the second face may have a second outer edge that defines the region. A relationship 0.75a≤b≤2a may be satisfied where a separation distance between the first outer edge and the second outer edge in the opposing direction is a and a separation distance between the first outer edge and the second outer edge in a direction orthogonal to the opposing direction and the first outer edge is b. In this case, by satisfaction of 0.75a≤b, an angle made of a corner portion made by the region and the first face becomes sufficiently large, and thus the concentration of stress on the corner portion made by the region and the first face is suppressed. By satisfaction of b≤2a, the volume of the first conductor portion can be sufficiently reduced, and thus the shrinkage amount of the configuration material of the first conductor portion can be reduced. Therefore, occurrence of cracks in the element is further suppressed.

In the electronic component according to one aspect of the present invention, the element may have a mounting surface, and the first recess may be provided in the mounting surface. In this case, in mounting the electronic component on another electronic device, electrical connection between the first conductor portion and the another electronic device can be easily achieved.

In the electronic component according to one aspect of the present invention, the element further may have an end face continuing from the mounting surface and provided with a second recess. The second recess may be integrally provided with the first recess. The mounting conductor further may include a second conductor portion disposed inside the second recess and have an L shape in cross section. In this case, for example, in mounting the electronic component on another electronic device by solder connection, the solder is provided not only on the mounting surface but also on the end face, and thus the mounting strength can be increased.

In the electronic component according to one aspect of the present invention, the second conductor portion may have a fourth face opposed to a bottom face of the second recess, a fifth face opposed to the fourth face, and a sixth face connecting fourth face and the fifth face. The sixth face may have a region overlapping with the fifth face as viewed from an opposing direction of the bottom face of the second recess and the fourth face. Therefore, the volume of the second conductor portion can be reduced while the area of the fifth face is maintained, as compared with a case where the fourth face is provided in such a way as not to overlap with the fifth face. As a result, the shrinkage amount of the configuration material of the second conductor portion can be reduced, and thus occurrence of cracks in the element is further suppressed.

The electronic component according to one aspect of the present invention may further include a coil conductor that configures a coil in the element. The mounting conductor may be formed by laminating mounting conductor layers. A coil axis of the coil may be provided along a laminating direction of the mounting conductor layers. In this case, as compared with a case where the third face is provided in such a way as not to overlap with the second face, the outer diameter of the coil can be increased and a Q value (quality factor) of the coil can be improved while the area of the second face is maintained.

### BRIEF DESCRIPTION OF THE DRAWINGS

FIG. 1 is a perspective view of a laminated coil component according to an embodiment;

FIG. 2 is an exploded perspective view of the laminated coil component in FIG. 1; and

FIG. 3 is a plan view illustrating a relationship between a coil and a mounting conductor illustrated in FIG. 1.

### DETAILED DESCRIPTION

Hereinafter, embodiments will be described in detail with reference to the accompanying drawings. In the description, the same reference numeral is used for the same elements or elements having the same function, and redundant description is omitted.

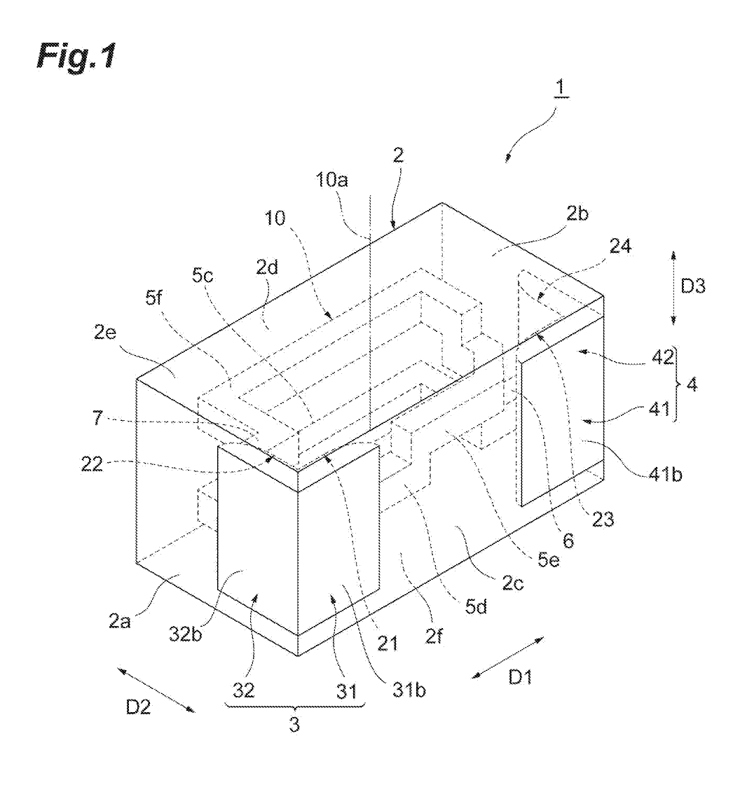

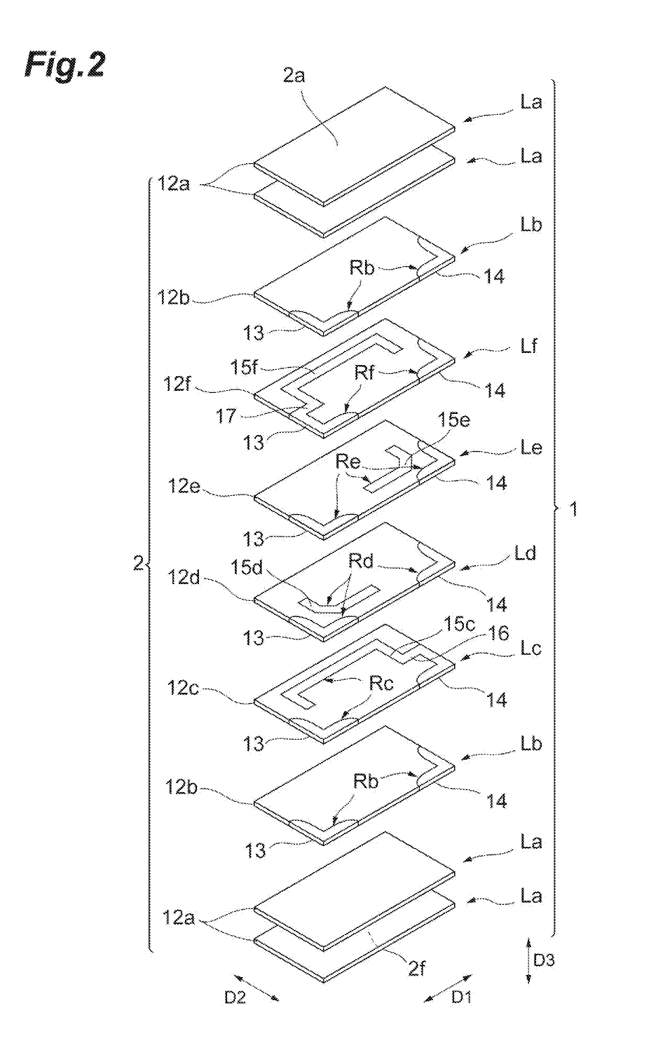

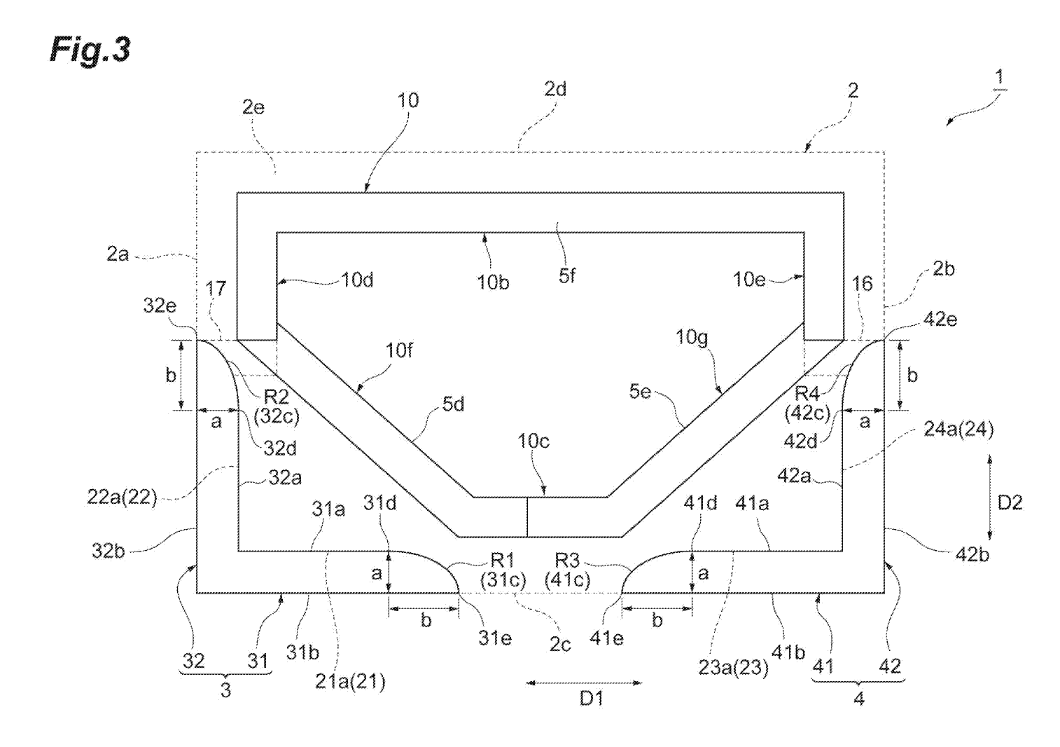

A laminated coil component according to an embodiment will be described with reference to FIGS. 1 to 3. FIG. 1 is a perspective view of a laminated coil component according to an embodiment. FIG. 2 is an exploded perspective view of the laminated coil component illustrated in FIG. 1. FIG. 3 is a plan view illustrating a relationship between a coil and a mounting conductor illustrated in FIG. 1. FIG. 3 is a plan view of a laminated coil component 1 as viewed from a side face 2e side. In FIG. 3, an element 2 and connection conductors 6 and 7 are illustrated by the broken lines.

As illustrated in FIGS. 1 to 3, the laminated coil component 1 according to an embodiment includes the element 2, mounting conductors 3 and 4, a plurality of coil conductors 5c, 5d, 5e, and 5f, and the connection conductors 6 and 7.

The element 2 has a rectangular parallelepiped shape. The rectangular parallelepiped shape includes a rectangular parallelepiped shape with chamfered corner portions and ridge portions, and a rectangular parallelepiped shape with rounded corner portions and ridge portions. The element 2 has end faces 2a and 2b and side faces 2c, 2d, 2e, and 2f. The end faces 2a and 2b are opposed to each other. The side faces 2c and 2d are opposed to each other. The side faces 2e and 2f are opposed to each other. Hereinafter, an opposing direction of the end faces 2a and 2b is a direction D1, an opposing direction of the side faces 2c and 2d is a direction D2, and an opposing direction of the side faces 2e and 2f is a direction D3. The directions D1, D2, and D3 are approximately orthogonal to one another.

The end faces 2a and 2b extend in the direction D2 in such a way as to connect the side faces 2c and 2d. The end faces 2a and 2b also extend in the direction D3 in such a way as to connect the side faces 2e and 2f. The side faces 2c and 2d extend in the direction D1 in such a way as to connect the end faces 2a and 2b. The side faces 2c and 2d also extend in the direction D3 in such a way as to connect the side faces 2e and 2f. The side faces 2e and 2f extend in the direction D2 in such a way as to connect the side faces 2c and 2d. The side faces 2e and 2f also extend in the direction D1 in such a way as to connect the end faces 2a and 2b.

The side face 2c is a mounting surface and is a surface opposed to another electronic device (not illustrated, for example, a circuit base material or an electronic component) when the laminated coil component 1 is mounted on the another electronic device. The end faces 2a and 2b are surfaces continuing from the mounting surface (that is, the side face 2c).

The length of the element 2 in the direction D1 is longer than the length of the element 2 in the direction D2 and the length of the element 2 in the direction D3. The length of the element 2 in the direction D2 and the length of the element 2 in the direction D3 are equivalent to each other. That is, in the present embodiment, the end faces 2a and 2b have a square shape, and the side faces 2c, 2d, 2e, and 2f have a rectangular shape. The length of the element 2 in the direction D1 may be equivalent to, or longer or shorter than the length of the element 2 in the direction D2 and the length of the element 2 in the length in the direction D3. The length of the element 2 in the direction D2 and the length of the element 2 in the direction D3 may be different from each other.

The “equivalent” in the present embodiment may include values having a slight difference or a manufacturing error that falls within a preset range, in addition to equal values. For example, if a plurality of values falls within a range of ±5% of an average value of the plurality of values, the plurality of values is defined to be equivalent.

Recesses 21, 22, 23, and 24 are provided in the element 2. The recesses 21 and 22 are integrally provided and correspond to the mounting conductor 3. The recesses 23 and 24 are integrally provided and correspond to the mounting conductor 4.

The recess 21 is provided in the side face 2c on the end face 2a side and is depressed toward the side face 2d. The recess 21 has a bottom face 21a. The bottom face 21a has a rectangular shape, for example. The recess 22 is provided in the end face 2a on the side face 2c side and is depressed toward the end face 2b. The recess 22 has a bottom face 22a. The bottom face 22a has a rectangular shape, for example. The recess 23 is provided in the side face 2c on the end face 2b side and is depressed toward the side face 2d. The recess 23 has a bottom face 23a. The bottom face 23a has a rectangular shape, for example. The recess 24 is provided in the end face 2b on the side face 2c side and is depressed toward the end face 2a. The recess 24 has a bottom face 24a. The bottom face 24a has a rectangular shape, for example.

The recesses 21, 22, 23, and 24 have the same shape, for example. The recesses 21, 22, 23, and 24 are provided to be separated from the side faces 2d, 2e, and 2f. The recess 21 and the recess 23 are provided to be separated from each other in the direction D1.

The element 2 is configured from a plurality of element layers 12a to 12f laminated in the direction D3. A specific lamination structure will be described below. In the actual element 2, the plurality of element layers 12a to 12f is integrated to such an extent that boundaries between the element layers cannot be visually recognized. The element layers 12a to 12f are configured from, for example, a magnetic material (Ni—Cu—Zn ferrite material, Ni—Cu—Zn—Mg ferrite material, or Ni—Cu ferrite material). The magnetic material that configures the element layers 12a to 12f may contain a Fe alloy or the like. The element layers 12a to 12f may be configured from a nonmagnetic material (a glass ceramic material, a dielectric material, or the like).

The mounting conductor 3 is disposed in the recesses 21 and 22. The mounting conductor 4 is disposed in the recesses 23 and 24. The mounting conductors 3 and 4 are separated from each other in the direction D1. The mounting conductors 3 and 4 have the same shape, for example. The mounting conductors 3 and 4 have an L-shape in cross section, for example. The mounting conductors 3 and 4 can be said to exhibit an L shape as viewed from the direction D3, for example. Electrolytic plating or electroless plating is applied to outer surfaces of the mounting conductors 3 and 4, thereby to form a plating layer on the outer surfaces. The plating layer contains Ni, Sn, Au, or the like.

The mounting conductor 3 is configured from a plurality of mounting conductor layers 13 having an L shape as viewed from the direction D3 and laminated in the direction D3. That is, the laminating direction of the mounting conductor layer 13 is the direction D3. In the actual mounting conductor 3, the plurality of mounting conductor layers 13 is integrated to such an extent that boundaries between the layers cannot be visually recognized. The mounting conductor 3 has conductor portions 31 and 32. The conductor portions 31 and 32 are integrally formed. The conductor portions 31 and 32 have an approximately rectangular plate shape. The conductor portions 31 and 32 have the same shape, for example.

The conductor portion 31 is disposed in the recess 21. In particular, as illustrated in FIG. 3, the conductor portion 31 has a first face 31a, a second face 31b, and a third face 31c. The first face 31a is opposed to the bottom face 21a in the direction D2. The second face 31b is opposed to the first face 31a in the direction D2. The third face 31c connects the first face 31a and the second face 31b. The third face 31c has a region R1 overlapping with the second face 31b as viewed from the direction D2. The region R1 is curved as a whole.

The first face 31a has an outer edge 31d that defines the region R1. The second face 31b has an outer edge 31e that defines the region R1. The outer edges 31d and 31e extend along the direction D3 and are parallel to each other. The outer edge 31d is positioned closer to the end face 2a than the outer edge 31e is, as viewed from the direction D2. A relationship 0.75a≤b≤2a is satisfied where a separation distance between the outer edge 31d and the outer edge 31e in the direction D2 is a and the separation distance between the outer edge 31d and the outer edge 31e in the direction D1 is b.

The conductor portion 32 is disposed in the recess 22. In particular, as illustrated in FIG. 3, the conductor portion 32 has a first face 32a, a second face 32b, and a third face 32c. The first face 32a is opposed to the bottom face 22a in the direction D1. The second face 32b is opposed to the first face 32a in the direction D1. The third face 32c connects the first face 32a and the second face 32b. The third face 32c has a region R2 overlapping with the second face 32b as viewed from the direction D1. The region R2 is curved as a whole.

The first face 32a has an outer edge 32d that defines the region R2. The second face 32b has an outer edge 32e that defines the region R2. The outer edges 32d and 32e extend along the direction D3 and are parallel to each other. The outer edge 32d is positioned closer to the side face 2c side than the outer edge 32e is, as viewed from the direction D1. A relationship 0.75a≤b≤2a is satisfied where a separation distance between the outer edge 32d and the outer edge 32e in the direction D1 is a and the separation distance between the outer edge 32d and the outer edge 32e in the direction D2 is b.

The first face 31a and the first face 32a are orthogonal to each other and continuous. The second face 31b and the second face 32b are orthogonal to each other and continuous.

The mounting conductor 4 is configured from a plurality of mounting conductor layers 14 having an L shape as viewed from the direction D3 and laminated in the direction D3. That is, the laminating direction of the mounting conductor layer 14 is the direction D3. In the actual mounting conductor 4, the plurality of mounting conductor layers 14 is integrated to such an extent that boundaries between the layers cannot be visually recognized. The mounting conductor 4 has conductor portions 41 and 42. The conductor portions 41 and 42 are integrally formed. The conductor portions 41 and 42 have an approximately rectangular plate shape. The conductor portions 41 and 42 have the same shape, for example.

The conductor portion 41 is disposed in the recess 23. In particular, as illustrated in FIG. 3, the conductor portion 41 has a first face 41a, a second face 41b, and a third face 41c. The first face 41a is opposed to the bottom face 23a in the direction D2. The second face 41b is opposed to the first face 41a in the direction D2. The third face 41c connects the first face 41a and the second face 41b. The third face 41c has a region R3 overlapping with the second face 41b as viewed from the direction D2. The region R3 is curved as a whole.

The first face 41a has an outer edge 41d that defines the region R3. The second face 41b has an outer edge 41e that defines the region R3. The outer edges 41d and 41e extend along the direction D3 and are parallel to each other. The outer edge 41d is positioned closer to the end face 2b side than the outer edge 41e is, as viewed from the direction D2. A relationship 0.75a≤b≤2a is satisfied where a separation distance between the outer edge 41d and the outer edge 41e in the direction D2 is a and the separation distance between the outer edge 41d and the outer edge 41e in the direction D1 is b.

The conductor portion 42 is disposed in the recess 24. In particular, as illustrated in FIG. 3, the conductor portion 42 has a first face 42a, a second face 42b, and a third face 42c. The first face 42a is opposed to the bottom face 24a in the direction D1. The second face 42b is opposed to the first face 42a in the direction D1. The third face 42c connects the first face 42a and the second face 42b. The third face 42c has a region R4 overlapping with the second face 42b as viewed from the direction D1. The region R4 is curved as a whole.

The first face 42a has an outer edge 42d that defines the region R4. The second face 42b has an outer edge 42e that defines the region R4. The outer edges 42d and 42e extend along the direction D3 and are parallel to each other. The outer edge 42d is positioned closer to the side face 2c than the outer edge 42e is, as viewed from the direction D1. A relationship 0.75a≤b≤2a is satisfied where a separation distance between the outer edge 42d and the outer edge 42e in the direction D1 is a and the separation distance between the outer edge 42d and the outer edge 42e in the direction D2 is b.

The first face 41a and the first face 42a are orthogonal to each other and continuous. The second face 41b and the second face 42b are orthogonal to each other and continuous.

A plurality of coil conductors 5c, 5d, 5e, and 5f is connected to one another to configure a coil 10 in the element 2. The coil 10 is disposed in such a way as to be opposed to the third faces 31c, 32c, 41c, and 42c. A coil axis 10a of the coil 10 is provided along the direction D3. The coil conductors 5c, 5d, 5e, and 5f are disposed in such a way as to at least partially overlap one another as viewed from the direction D3. The coil conductors 5c, 5d, 5e, and 5f are disposed separated from the end faces 2a and 2b and the side faces 2c, 2d, 2e, and 2f.

As illustrated in FIG. 3, the coil 10 has a hexagonal shape as viewed from the direction D3. The coil 10 has portions lob, 10c, 10d, 10e, 10f, and 10g.

The portion 10b is disposed along the side face 2d. The length of the portion 10b in the direction D1 is from 30% to 98%, both inclusive, more favorably from 60% to 98%, both inclusive, of the length of the element 2 in the direction D1. The portion 10b is disposed in a central portion of the element 2 in the direction D1. That is, the separation distance between the portion 10b and the end face 2a in the direction D1 and the separation distance between the portion 10b and the end face 2b in the direction D1 are equivalent to each other. The separation distance between the portion 10b and the side face 2d in the direction D2 is from 1.5% to 30%, both inclusive, more favorably from 1.5% to 10%, both inclusive, of the length of the element 2 in the direction D2.

The portion 10c is disposed along the side face 2c. The length of the portion 10c in the direction D1 is from 5% to 95%, both inclusive, more favorably from 60% to 95%, both inclusive, of the length of the element 2 in the direction D1. The portion 10c is disposed in a central portion of the element 2 in the direction D1. That is, the separation distance between the portion 10c and the end face 2a in the direction D1 and the separation distance between the portion 10c and the end face 2b in the direction D1 are equivalent to each other. The separation distance between the portion 10c and the side face 2c in the direction D2 is from 1.5% to 60%, both inclusive, more favorably from 1.5% to 10%, both inclusive, of the length of the element 2 in the direction D2.

The portion 10d is connected to an end portion of the portion 10b on the end face 2a side, and is disposed along the end face 2a. The length of the portion 10d in the direction D2 is from 10% to 90%, both inclusive, more favorably from 10% to 50%, both inclusive, of the length of the element 2 in the direction D2.

The portion 10e is connected to an end portion of the portion 10b on the end face 2b side, and is disposed along the end face 2b. The length of the portion 10e in the direction D2 is from 10% to 90%, both inclusive, more favorably from 10% to 50%, both inclusive, of the length of the element 2 in the direction D2. The portion 10e has the same shape as the portion 10d, for example.

The portion 10f connects an end portion of the portion 10c on the end face 2a side and an end portion of the portion 10d on the side face 2c side. The portion 10g connects an end portion of the portion 10c on the end face 2b side and an end portion of the portion 10e on the side face 2c side.

The coil conductor 5c configures one end portion of the coil 10. One end portion of the coil conductor 5c and the connection conductor 6 are adjacent to each other in the direction D1 and are connected to each other. Another end portion of the coil conductor 5c and one end portion of the coil conductor 5d are adjacent to each other in the direction D3 and are connected to each other. The other end portion of the coil conductor 5d and one end portion of the coil conductor 5e are adjacent to each other in the direction D3 and are connected to each other. The other end portion of the coil conductor 5e and one end portion of the coil conductor 5f are adjacent to each other in the direction D3 and are connected to each other. The other end portion of the coil conductor 5f and the connection conductor 7 are adjacent to each other in the direction D1 and are connected to each other.

The coil conductors 5c, 5d, 5e, and 5f are configured from a plurality of coil conductor layers 15c, 15d, 15e, and 15f laminated in the direction D3. That is, the plurality of coil conductor layers 15c, 15d, 15e, and 15f is disposed in such a way that all the coil conductor layers overlap one another as viewed from the direction D3. The coil conductors 5c, 5d, 5e, and 5f may be configured from one set of coil conductor layers 15c, 15d, 15e, and 15f. FIG. 2 illustrates only one set of coil conductor layers 15c, 15d, 15e, and 15f. In the actual coil conductors 5c, 5d, 5e, and 5f, the plurality of coil conductor layers 15c, 15d, 15e, and 15f is integrated to such an extent that boundaries between the layers cannot be visually recognized.

The connection conductor 6 extends in the direction D1 and is connected to the coil conductor 5c of the coil 10 and the conductor portion 42. The connection conductor 7 extends in the direction D1 and is connected to the coil conductor 5f and the conductor portion 32. The connection conductors 6 and 7 are configured from a plurality of connection conductor layers 16 and 17 laminated in the direction D3. In FIG. 2, only one set of connection conductor layers 16 and 17 is illustrated. In the actual connection conductors 6 and 7, the plurality of connection conductor layers 16 and 17 is integrated to such an extent that boundaries between the layers cannot be visually recognized.

The mounting conductor layers 13 and 14, the coil conductor layers 15c, 15d, 15e, and 15f, and the connection conductor layers 16 and 17 are configured from a conductive material (for example, Ag or Pd). These layers may be configured from the same material or different materials. These layers have an approximately rectangular shape in cross section.

The laminated coil component 1 has a plurality of layers La, Lb, Lc, Ld, Le, and Lf. For example, the laminated coil component 1 is configured from two layers La, one layer Lb, three layers Lc, three layers Ld, three layers Le, three layers Lf, one layer Lb, and two layers La laminated in order from the side face 2f side. In FIG. 2, each one of the three layers Lc, three layers Ld, three layers Le, and three layers Lf is illustrated, and the other two are not illustrated.

The layer La is configured from the element layer 12a.

The layer Lb is configured from the element layer 12b in combination with the mounting conductor layers 13 and 14. The element layer 12b is provided with defect portions Rb. The defect portions Rb have shapes corresponding to the shapes of the mounting conductor layers 13 and 14. The mounting conductor layers 13 and 14 are fit to the defect portions Rb. The element layer 12b and the mounting conductor layers 13 and 14 as a whole have a complementary relationship with each other.

The layer Lc is configured from the element layer 12c in combination with the mounting conductor layers 13 and 14 and the coil conductor layer 15c. The element layer 12c is provided with defect portions Rc. The defect portions Rc have shapes corresponding to the shapes of the mounting conductor layers 13 and 14, the coil conductor layer 15c. The mounting conductor layers 13 and 14, the coil conductor layer 15c, and the connection conductor layer 16 are fit to the defect portions Rc. The element layer 12c, and the mounting conductor layers 13 and 14, the coil conductor layer 15c, and the connection conductor layer 16 as a whole have a complementary relationship with each other.

The layer Ld is configured from the element layer 12d in combination with the mounting conductor layers 13 and 14 and the coil conductor layer 15d. The element layer 12d is provided with defect portions Rd. The defect portions Rd have shapes corresponding to the shapes of the mounting conductor layers 13 and 14 and the coil conductor layer 15d. The mounting conductor layers 13 and 14 and the coil conductor layer 15d are fit to the defect portions Rd. The element layer 12d, and the mounting conductor layers 13 and 14, and the coil conductor layer 15d as a whole have a complementary relationship with each other.

The layer Le is configured from the element layer 12e in combination with the mounting conductor layers 13 and 14 and the coil conductor layer 15e. The element layer 12e is provided with defect portions Re. The defect portions Re have shapes corresponding to the shapes of the mounting conductor layers 13 and 14 and the coil conductor layer 15e. The mounting conductor layers 13 and 14 and the coil conductor layer 15e are fit to the defect portions Re. The element layer 12e, and the mounting conductor layers 13 and 14 and the coil conductor layer 15e as a whole have a complementary relationship with each other.

The layer Lf is configured from the element layer 12f in combination with the mounting conductor layers 13 and 14, the coil conductor layer 15f, and the connection conductor layer 17. The element layer 12f is provided with defect portions Rf. The defect portions Rf have shapes corresponding to the shapes of the mounting conductor layers 13 and 14, the coil conductor layer 15f, and the connection conductor layer 17. The mounting conductor layers 13 and 14, the coil conductor layer 15f, and the connection conductor layer 17 are fit to the defect portions Rf. The element layer 12f, and the mounting conductor layers 13 and 14, the coil conductor layer 15f, and the connection conductor layer 17 as a whole have a complementary relationship with each other.

The defect portions Rb, Rc, Rd, Re, Rf are integrated to configure the aforementioned recesses 21, 22, 23, and 24. The widths of the defect portions Rb, Rc, Rd, Re, and Rf (hereinafter, the widths of the defect portions) are basically set to be larger than the widths of the mounting conductor layers 13 and 14, the coil conductor layers 15c, 15d, 15e, and 15f, and the connection conductor layers 16 and 17 (hereinafter, the widths of the conductor portions). To improve the adhesive property among the element layers 12b, 12c, 12d, 12e, and 12f, the mounting conductor layers 13 and 14, the coil conductor layers 15c, 15d, 15e, and 15f, and the connection conductor layers 16 and 17, the widths of the defect portions may be purposely set to be narrower than the widths of the conductor portions. A value obtained by subtracting the width of the conductor portion from the width of the defect portion is favorably, for example, from −3 μm to 10 μm, both inclusive, and more favorably from 0 μm to 10 μm, both inclusive.

An example of a method for manufacturing the laminated coil component 1 according to an embodiment will be described.

First, an element forming layer is formed by applying an element paste containing a configuration material of the above-described element layers 12a to 12f and a photosensitive material to a base material (for example, a PET film) The photosensitive material contained in the element paste may be either a negative type or a positive type, and a known photosensitive material can be used. Next, the element forming layer is exposed and developed by a photolithography method using a Cr mask, for example, to form an element pattern from which a shape correspond to the shape of a conductor forming layer described below is removed, on the base material. The element pattern is a layer to serve as the element layers 12b, 12c, 12d, 12e, and 12f after thermal treatment. That is, the element pattern provided with defect portions that are to serve as the defect portions Rb, Rc, Rd, Re, and Rf is formed. The “photolithography method” of the present embodiment is not limited to a type of mask or the like, and may be any method of processing a desired pattern by exposing and developing a layer to be processed containing a photosensitive material.

Meanwhile, a conductor forming layer is formed by applying a conductor paste containing configuration materials of the mounting conductor layers 13 and 14, the coil conductor layers 15c, 15d, 15e, and 15f, and the connection conductor layer 16 and 17, and a photosensitive material to the base material (for example, a PET film). The photosensitive material contained in the conductor paste may be either a negative type or a positive type, and a known photosensitive material can be used. Next, the conductor forming layer is exposed and developed by a photolithography method using a Cr mask, for example, to faun a conductor pattern on the base material. The conductor pattern is a layer to serve as the mounting conductor layers 13 and 14, the coil conductor layers 15c, 15d, 15e, and 15f and the connection conductor layer 16 and 17 after thermal treatment.

Next, the element forming layer is transferred from the base material onto a support. In the present embodiment, two element fanning layers are laminated on the support by repetition of the transfer step of the element forming layer twice. These element forming layers are layers to serve as the layers La after thermal treatment.

Next, the conductor patterns and the element patterns are laminated in the direction D3 by being repeatedly transferred them onto the support. Specifically, first, the conductor pattern is transferred from the base material onto the element forming layer. Next, the element pattern is transferred from the base material onto the element forming layer. The conductor pattern is combined with the defect portion of the element pattern, and the element pattern and the conductor pattern become the same layer on the element forming layer. Further, the transfer steps of the conductor pattern and element pattern are repeatedly performed, and the conductor pattern and the body pattern are laminated in a state of being combined with each other. According to this process, layers to serve as the layers Lb, Lc, Ld, Le, and Lf after thermal treatment are laminated.

Next, the element forming layer is transferred from the base material onto the layer laminated in the transfer step of the conductor pattern and the element pattern. In the present embodiment, two element forming layers are laminated on the layer by repetition of the transfer step of the element forming layer twice. These element forming layers are layers to serve as the layers La after thermal treatment.

By the above process, a laminate that configures the laminated coil component 1 after thermal treatment is formed on the support. Next, the obtained laminate is cut into a predetermined size. Next, after a debinding process is performed for the cut laminate, thermal treatment is performed. The thermal treatment temperature is, for example, about 850 to 900° C. Next, if necessary, a plating layer is formed on the outer surfaces of the mounting conductors 3 and 4. According to this process, the laminated coil component 1 is obtained.

As described above, in the conductor portions 31 and 41 of the mounting conductors 3 and 4, the third faces 31c and 41c have the regions R1 and R2 overlapping with the second faces 31b and 41b. Therefore, as compared with a case where the third faces 31c and 41c are provided in such a way as not to overlap with the second faces 31b and 41b, the volume of the conductor portions 31 and 41 can be reduced while the areas of the second faces 31b and 41b are maintained. As a result, the shrinkage amount of the configuration material of the conductor portions 31 and 41 can be reduced, and thus the occurrence of cracks in the element 2 is suppressed.

The element 2 has the side face 2c as a mounting surface. The recesses 21 and 23 in which the conductor portions 31 and 41 are disposed are provided in the side face 2c. Therefore, when the laminated coil component 1 is mounted on another electronic device, electrical connection between the conductor portions 31 and 41 and the another electronic devices can be easily achieved.

The element 2 has the end faces 2a and 2b continuing from the side face 2c. The end faces 2a and 2b are provided with the recesses 22 and 24. The mounting conductors 3 and 4 have the conductor portions 32 and 42 disposed in the recesses 22 and 24. The mounting conductors 3 and 4 have an L shape in cross section. Therefore, for example, when the laminated coil component 1 is mounted on another electronic device by solder connection, the solder is provided not only on the side face 2c but also on the end faces 2a and 2b. Therefore, the mounting strength can be further enhanced.

The conductor portions 32 and 42 have the third faces 32c and 42c, and the third faces 32c and 42c have the regions R3 and R4 overlapping with the second faces 32b and 42b. Therefore, as compared with a case where the third faces 32c and 42c are provided in such a way as not to overlap with the second faces 32b and 42b, the volume of the conductor portions 32 and 42 can be reduced while the areas of the second faces 32b and 42b are maintained. As a result, the shrinkage amount of the configuration material of the conductor portions 32 and 42 can be reduced, and thus the occurrence of cracks in the element 2 is further suppressed.

According to the research and study by the inventors of the present invention, the cracks are more likely to occur in the vicinity of the conductor portions 31, 32, 41, and 42 and at the portions separated from the conductor portions 31, 32, 41, and 42 in the element 2. According to the present embodiment, occurrence of such cracks can be suppressed.

For example, in a case where the regions R1 to R4 are configured from a plurality of planes having a chamfered shape, there is a possibility of concentration of stress on corners of the regions R1 to R4. In contrast, in the laminated coil component 1, the regions R1 to R4 are curved, and thus the stress can be relieved. Therefore, occurrence of cracks in the element 2 is further suppressed.

In the conductor portions 31 and 41, the relationship 0.75a≤b≤2a is satisfied where the separation distance between the outer edges 31d and 41d and the outer edges 31e and 41e in the direction D2 is a and the separation distance between the outer edges 31d and 41d and the outer edges 31e and 41e in the direction D1 is b. In the conductor portions 32 and 42, the relationship 0.75a≤b≤2a is satisfied where the separation distance between the outer edges 32d and 42d and the outer edges 32e and 42e in the direction D1 is a and the separation distance between the outer edges 32d and 42d and the outer edges 32e and 42e in the direction D2 is b. By satisfaction of 0.75a≤b, an angle of a corner portion made by the region R1 and the first face 31a, an angle of a corner portion made by the region R2 and the first face 32a, an angle of a corner portion made by the region R3 and the first face 41a, and an angle of a corner portion made by the region R4 and the first face 42a become sufficiently large, and thus concentration of stress on these corner portions is suppressed. By satisfaction of b≤2a, the volume of the conductor portions 31, 32, 41, and 42 can be sufficiently reduced, and thus the shrinkage amount of the configuration material of the conductor portions 31, 32, 41, and 42 can be reduced. Therefore, occurrence of cracks in the element 2 is further suppressed.

The mounting conductors 3 and 4 are formed of the mounting conductor layers 13 and 14 laminated in the direction D3. The coil axis 10a of the coil 10 is provided along the direction D3. Therefore, as compared with a case where the third faces 31c, 32c, 41c, and 42c are provided in such a way as not to overlap with the second faces 31b, 32b, 41b, and 42b in the conductor portions 31, 32, 41, and 42, the outer diameter of the coil 10 can be increased and 42b, and a Q value (quality factor) of the coil 10 can be improved while the areas of the second faces 31b, 32b, 41b. As compared with the case where the third faces 31c, 32c, 41c, and 42c are provided in such a way as not to overlap with the second faces 31b, 32b, 41b, and 42b, close contact of the coil 10 and the mounting conductors 3 and 4 is suppressed. As a result, the outer diameter of the coil 10 can be increased and the Q value of the coil 10 can be improved while the occurrence of cracks between the coil 10 and the mounting conductors 3 and 4 can be suppressed.

The present invention is not limited to the above-described embodiment, and various modifications can be made.

The laminated coil component 1 may further include a core portion inside the coil 10 as viewed from the direction D3. The core portion may be hollow. That is, the laminated coil component 1 may be an air-core coil. The core portion may be solid and may be configured from a magnetic material different from the configuration material of the element 2, for example. The core portion may penetrate the element 2 in the direction D3 or may be covered with the element 2 at both end portions in the direction D3. The laminated coil component 1 may further include a spacer disposed between the coil conductors 5c, 5d, 5e, and 5f in the direction D3, and the spacer may be configured from a magnetic material or a nonmagnetic material different from the configuration material of the element 2.

In the laminated coil component 1, at least one of the third faces 31c, 32c, 41c, and 42c may have the regions R1, R2, R3, and R4. The recesses 21, 22, 23, and 24 do not necessarily have the same shape. Similarly, the conductor portions 31, 32, 41, and 42 do not necessarily have the same shape.

The mounting conductor 3 may just have either one of the conductor portions 31 and 32, and the element 2 may just be provided with either one of the recesses 21 and 22, corresponding to the conductor portions 31 and 32. The mounting conductor 4 may just have either one of the conductor portions 41 and 42, and the element 2 may just be provided with either one of the recesses 23 and 24, corresponding to the conductor portions 41 and 42.

The regions R1, R2, R3, and R4 may partially include a plane, or the whole regions may be configured from one or a plurality of planes. The regions R1, R2, R3, and R4 may be configured from a plurality of planes and may have a chamfered shape.

In the above-described embodiment, the laminated coil component 1 has been described as an example of an electronic component. However, the present invention is not limited to the example, and can be applied to a laminated ceramic capacitor, a laminated varistor, a laminated piezoelectric actuator, a laminated thermistor, or another electronic component such as a laminated composite component.

What is claimed is:

1. An electronic component comprising:
an element provided with a first recess; and
a mounting conductor including a first conductor portion disposed in the first recess, wherein
the first conductor portion has a first face opposed to a bottom face of the first recess, a second face opposed to the first face, and a third face connecting the first face and the second face, and
the third face has a region overlapping with the second face as viewed from an opposing direction of the bottom face of the first recess and the first face.

2. The electronic component according to claim 1, wherein the region is curved.

3. The electronic component according to claim 1, wherein
the first face has a first outer edge defining the region,
the second face having a second outer edge defining the region, and
a relationship 0.75a≤b≤2a is satisfied where a separation distance between the first outer edge and the second outer edge in the opposing direction is a and a separation distance between the first outer edge and the second outer edge in a direction orthogonal to the opposing direction and the first outer edge is b.

4. The electronic component according to claim 1, wherein
the element has a mounting surface, and
the first recess is provided in the mounting surface.

5. The electronic component according to claim 4, wherein
the element further has an end face continuing from the mounting surface and provided with a second recess,
the second recess is integrally provided with the first recess, and
the mounting conductor further includes a second conductor portion disposed inside the second recess and has an L shape in cross section.

6. The electronic component according to claim 5, wherein
the second conductor portion has a fourth face opposed to a bottom face of the second recess, a fifth face opposed to the fourth face, and a sixth face connecting the fourth face and the fifth face, and
the sixth face has a region overlapping with the fifth face as viewed from an opposing direction of the bottom face of the second recess and the fourth face.

7. The electronic component according to claim 5, further comprising:
a coil conductor configuring a coil in the element, wherein
the mounting conductor is formed by laminating mounting conductor layers, and
a coil axis of the coil is provided along a laminating direction of the mounting conductor layers.
